(19) United States
(12) Patent Application Publication
(10) Pub. No.: US 2026/0018339 A1
(43) Pub. Date: Jan. 15, 2026

(54) MULTILAYER CERAMIC ELECTRONIC COMPONENT AND METHOD OF MANUFACTURING THE SAME

(71) Applicant: TAIYO YUDEN CO., LTD., Tokyo (JP)

(72) Inventors: Maiko YAMANE, Tokyo (JP); Yusuke KOWASE, Tokyo (JP); Yuji TAKITA, Tokyo (JP)

(73) Assignee: TAIYO YUDEN CO., LTD., Tokyo (JP)

(21) Appl. No.: 19/330,403

(22) Filed: Sep. 16, 2025

Related U.S. Application Data
(63) Continuation of application No. PCT/JP2024/013288, filed on Mar. 29, 2024.

(30) Foreign Application Priority Data
Mar. 30, 2023 (JP) 2023-055342

(51) Int. Cl. H01G 4/224; H01G 4/008; H01G 4/012; H01G 4/12; H01G 4/30

(52) U.S. Cl. CPC H01G 4/224; H01G 4/008; H01G 4/012; H01G 4/12; H01G 4/30

(57) ABSTRACT

A multilayer ceramic electronic component includes a capacitance forming portion in which dielectric layers and internal electrodes are alternately stacked along a first axis direction, the capacitance forming portion including a pair of main surfaces, a pair of side surfaces, and a pair of end surfaces, a protective layer that covers the capacitance forming portion with the main surfaces and the side surfaces as interfaces, particles that are present across the capacitance forming portion and the protective layer, and in which, when a longest portion in a cross section including a direction along the first axis direction is defined as a long side and a longest portion in portions orthogonal to the long side is defined as a short side, a ratio of the short side to the long side is equal to or less than ⅓, and external electrodes that cover at least the end surfaces, respectively.

### CROSS-REFERENCE TO RELATED APPLICATION

This application is based upon and claims the benefit of priority of the prior International Patent Application No. PCT/JP2024/013288, filed on Mar. 29, 2024, which claims the benefits of priorities of Japanese Patent Application No. 2023-055342 filed on Mar. 30, 2023, the entire contents of which are incorporated herein by reference.

### FIELD

A certain aspect of the present disclosure relates to a multilayer ceramic electronic component and a method of manufacturing the same.

### BACKGROUND

In recent years, a multilayer ceramic electronic component has been known which includes a capacitance forming portion in which internal electrode layers and dielectric layers are alternately stacked and side margins formed on the side surfaces of the capacitance forming portion. In such a multilayer ceramic electronic component, the number of stacked layers is increasing. As the number of stacked layers of the multilayer ceramic electronic component increases, it is considered that a deviation occurs when the green sheets are stacked, and it becomes difficult to maintain the rectangularity of the chip. In order to solve such a problem, ceramic green sheets are conventionally attached to the side surface of the capacitance forming portion to form the side margins. The capacitance forming portion in such a method is obtained by cutting the stacked green sheets into individual pieces, and thus the rectangularity of the chip is easily maintained. However, the side margins formed by the bonding may peel off. Therefore, various proposals have been made to suppress the peeling of the side margins (for example, see Patent document 1: Japanese Laid-Open Patent Publication No. 2019-106528).

### SUMMARY OF THE INVENTION

According to a first aspect of the present disclosure, there is provided a multilayer ceramic electronic component including: a capacitance forming portion in which dielectric layers and internal electrodes are alternately stacked along a first axis direction, the capacitance forming portion including a pair of main surfaces facing each other along the first axis direction, a pair of side surfaces facing each other in a second axis direction orthogonal to the first axis direction and on which the internal electrodes are exposed, and a pair of end surfaces facing each other in a third axis direction orthogonal to the first axis direction and the second axis direction; a protective layer that covers the capacitance forming portion with the main surfaces and the side surfaces as interfaces; particles that are present across the capacitance forming portion and the protective layer, and in which, when a longest portion in a cross section including a direction along the first axis direction is defined as a long side and a longest portion in portions orthogonal to the long side is defined as a short side, a ratio of the short side to the long side is equal to or less than ⅓; and a pair of external electrodes that cover at least the end surfaces, respectively.

According to a second aspect of the present disclosure, there is provided a method of manufacturing a multilayer ceramic electronic component including: forming an unfired multilayer portion in which dielectric layers and internal electrodes are alternately stacked along a first axis direction, the unfired multilayer portion including a pair of main surfaces facing each other along the first axis direction, a pair of side surfaces facing each other in a second axis direction orthogonal to the first axis direction and on which the internal electrodes are exposed, and a pair of end surfaces facing each other in a third axis direction orthogonal to the first axis direction and the second axis direction, the internal electrodes being led out to the pair of end surfaces, respectively; spraying particles each having a ratio of a short side to a long side of ⅓ or less to the side surfaces; and sticking ceramic sheets on the side surfaces to which the particles are sprayed, the ceramic sheets forming the side margin portions.

### BRIEF DESCRIPTION OF THE DRAWINGS

FIG. 1 is a perspective view of a multilayer ceramic capacitor according to an embodiment.

FIG. 2A is a cross-sectional view taken along a line A1-A1 in FIG. 1.

FIG. 2B is an enlarged view schematically illustrating an S1 portion in FIG. 2A.

FIG. 2C is an enlarged view schematically illustrating an S2 portion in FIG. 2A.

FIG. 3 is a cross-sectional view taken along a line A2-A2 in FIG. 1.

FIG. 4A is a diagram illustrating a short side and a long side of a first particle.

FIGS. 4B and 4C are explanatory diagrams illustrating an inclination angle α of the first particle with respect to a perpendicular line of an interface.

FIG. 4D is an explanatory diagram schematically illustrating a state in which the first particle is provided along a perpendicular line direction of the interface.

FIG. 5A is a conceptual diagram schematically illustrating a state in which an organic component passes through first particles at an interface between a multilayer portion and a side margin.

FIG. 5B is a conceptual diagram schematically illustrating a state in which the amount of the first particles is increased from the amount of the first particles illustrated in FIG. 5A.

FIG. 5C is a conceptual diagram schematically illustrating a state in which the amount of the first particles is further increased from the amount of the first particles illustrated in FIG. 5B.

FIG. 6 is a flowchart illustrating an example of a method of manufacturing the multilayer ceramic capacitor according to the embodiment.

FIG. 7 is a perspective view illustrating a part of steps included in the method of manufacturing the multilayer ceramic capacitor according to the embodiment.

FIG. 8 is an explanatory view schematically illustrating a state in which first particles are sprayed onto a main surface of a capacitance forming portion.

FIGS. 9A to 9D are explanatory views illustrating some steps included in the method of manufacturing the multilayer ceramic capacitor according to the embodiment.

FIG. 10 is a plan view illustrating a cutting step included in the method of manufacturing the multilayer ceramic capacitor according to the embodiment.

FIG. 11A is a perspective view of an unfired multilayer portion formed by cutting a multilayer sheet on which cover portions are stacked.

FIG. 11B is an explanatory view schematically illustrating a state in which first particles are sprayed to a side surface of the unfired multilayer portion.

FIG. 12 is an explanatory view schematically illustrating a state in which green sheets for forming side margins are stuck on the side surfaces of the unfired multilayer portion to which the first particles have been sprayed.

### DETAILED DESCRIPTION

In order to suppress the side margins from peeling off, it is conceivable to increase an amount of the organic binder in the green sheet to improve the adhesion of the side margins. However, when the amount of the organic binder is increased, the debinding property is deteriorated, or the firing temperature is increased. When the debinding property is deteriorated, the time required for debinding is prolonged. In addition, when the firing temperature is increased, there is a concern that the electrical characteristics of the multilayer ceramic electronic component may be deteriorated, such as the internal electrodes becoming spherical or the continuity modulus of the internal electrodes being deteriorated. Such a problem may also occur in Patent Document 1.

The embodiments of the present disclosure provide a multilayer ceramic electronic component that can ensure a favorable debinding property while mainly suppressing peeling of the side margins.

Hereinafter, a multilayer ceramic capacitor (MLCC) according to an embodiment of the present disclosure will be described with reference to the accompanying drawings. In the drawings, the dimensions, ratios, and the like of the respective portions may not be illustrated so as to completely match the actual ones. For convenience of drawing, details may be omitted or components themselves may be omitted depending on the drawings. In the drawings, an X-axis, a Y-axis, and a Z-axis orthogonal to each other are illustrated as appropriate. In the following description, the Z-axis direction corresponds to a first axis direction, and the Y-axis direction corresponds to a second axis direction. The X-axis direction corresponds to a third axis direction.

### Embodiment

### Configuration of Multilayer Ceramic Capacitor

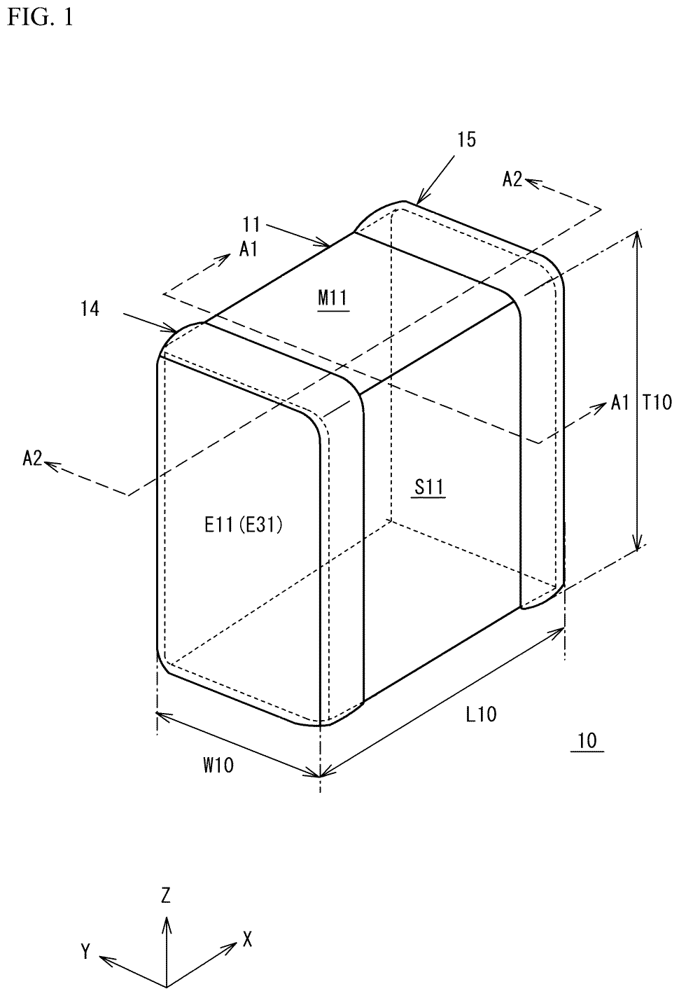

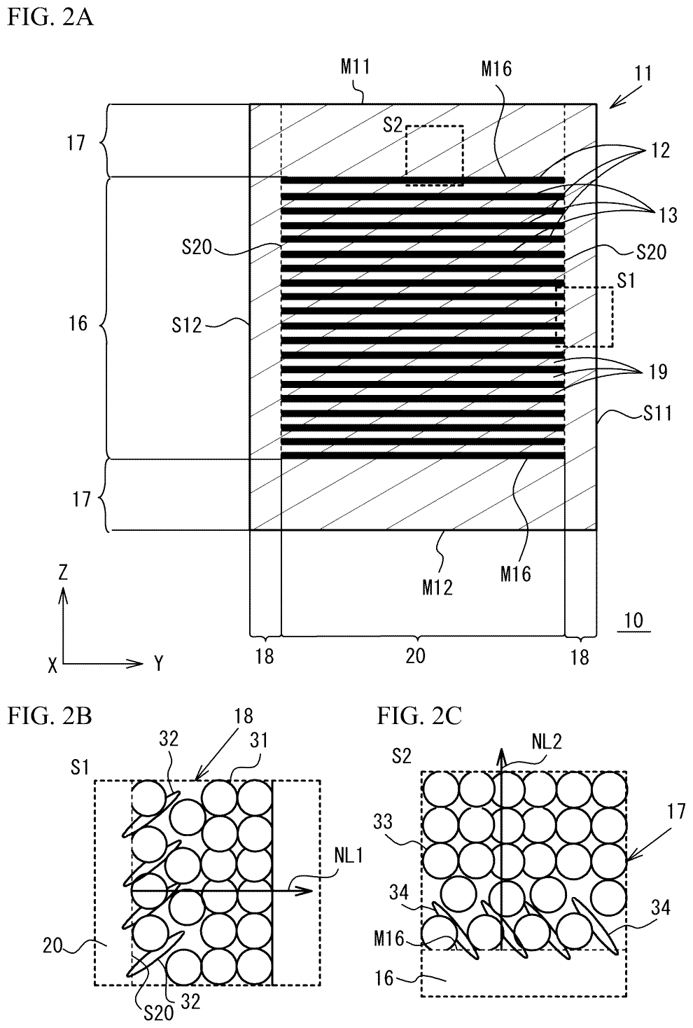

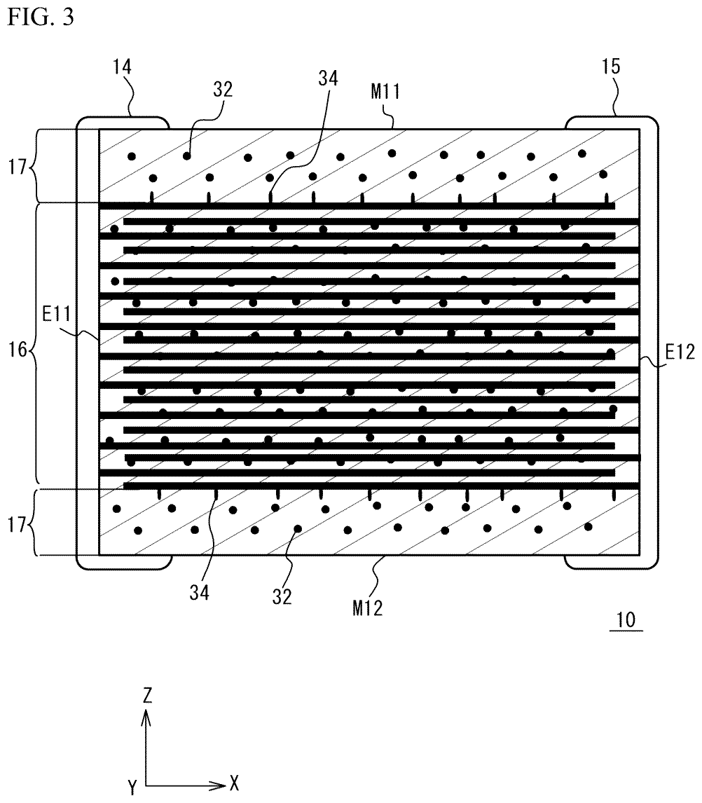

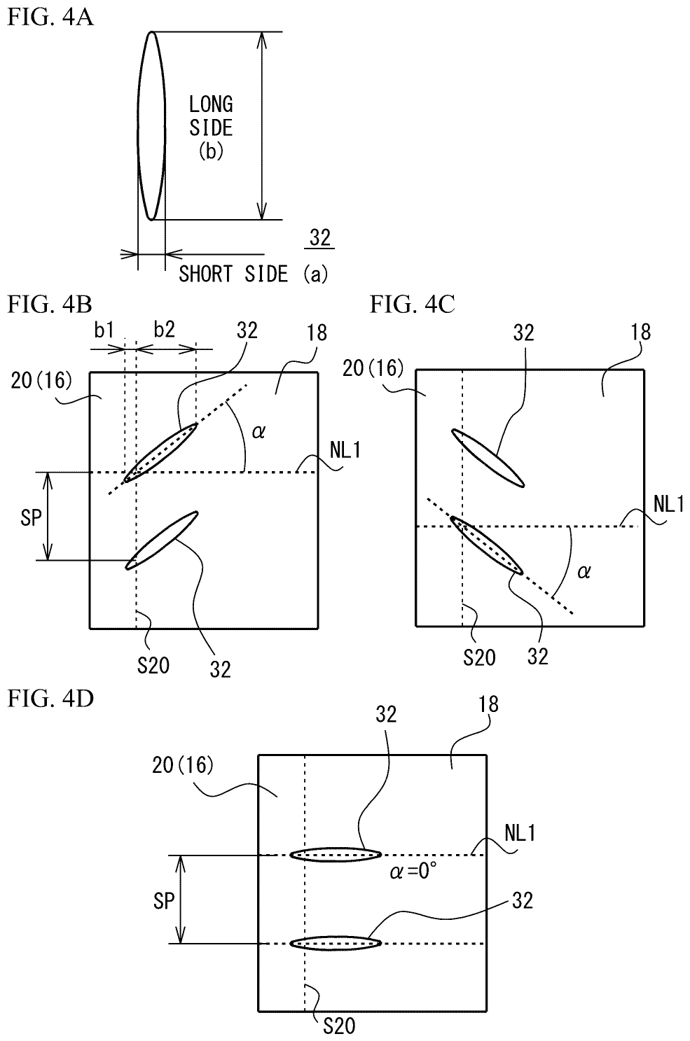

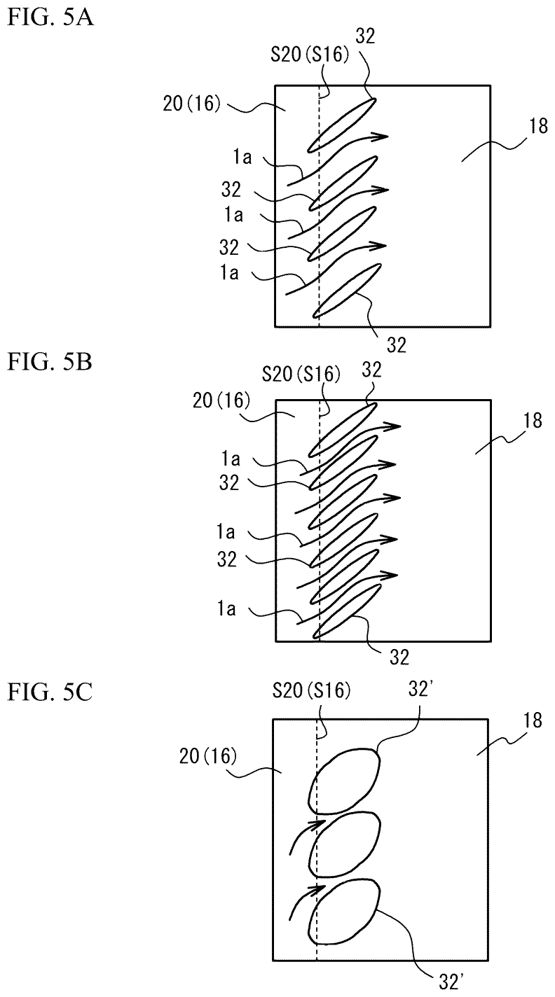

First, a multilayer ceramic capacitor 10 of an embodiment will be described with reference to FIGS. 1 to 5C. FIG. 1 is a perspective view of a multilayer ceramic capacitor according to an embodiment. FIG. 2A is a cross-sectional view taken along a line Al-A1 in FIG. 1, FIG. 2B is an enlarged view schematically illustrating an S1 portion in FIG. 2A, and FIG. 2C is an enlarged view schematically illustrating an S2 portion in FIG. 2A. FIG. 3 is a cross-sectional view taken along a line A2-A2 in FIG. 1. FIG. 4A is a diagram illustrating a short side and a long side of a first particle 32 (34). FIGS. 4B and 4C are explanatory diagrams illustrating an inclination angle α of the first particle 32 with respect to a perpendicular line NL1 of a side surface S20 of a multilayer portion 20, which is an interface between the multilayer portion 20 and the side margin portion 18. FIG. 4D is an explanatory diagram schematically illustrating a state in which the first particle 32 is provided along the direction of the perpendicular line NL1 of the interface. FIG. 5A is a conceptual diagram schematically illustrating a state in which an organic component passes through the first particles 32 at the interface between the multilayer portion 20 and the side margin portion 18, FIG. 5B is a conceptual diagram schematically illustrating a state in which the amount of the first particles 32 is increased from the amount of the first particles 32 illustrated in FIG. 5A, and FIG. 5C is a conceptual diagram schematically illustrating a state in which the amount of the first particles 32 is further increased from the amount of the first particles 32 illustrated in FIG. 5B. In the multilayer ceramic capacitor 10, the X-axis direction is a length direction, the Y-axis direction is a width direction, and the Z-axis direction is a height direction.

The multilayer ceramic capacitor 10 includes a ceramic body 11, a first external electrode 14 provided at one end of the multilayer ceramic capacitor 10 in the length direction, and a second external electrode 15 provided at the other end thereof.

The ceramic body 11 is formed as a hexahedron having first and second main surfaces M11 and M12 perpendicular to the Z-axis, first and second end surfaces E11 and E12 perpendicular to the X-axis, and first and second side surfaces S11 and S12 perpendicular to the Y-axis. The “hexahedron” may be substantially a hexahedron, and for example, ridges connecting the surfaces of the ceramic body 11 may be rounded.

The main surfaces M11 and M12, the end surface E11 and E12, and the side surface S11 and S12 of the ceramic body 11 are all formed as flat surfaces. The flat surface according to the present embodiment may not be strictly a plane as long as it is a surface recognized as flat when viewed as a whole, and includes, for example, a surface having a minute uneven shape of the surface, a gently curved shape existing in a predetermined range, or the like.

The multilayer ceramic capacitor 10 of the present embodiment is a tall height type in which a height T [10] is about 1.3 times or more a width W [10]. In the multilayer ceramic capacitor 10, the capacitance is increased by increasing the height [T10]. It is desirable that the height T be 1.5 times or more the width W [10]. The height T [10] may be, for example, 1.6 times or 1.7 times the width W [10], or may be a higher magnification. This allows the multilayer ceramic capacitor 10 to have a further increased capacitance.

In addition, in the present embodiment, the condition of the height T [10] is defined by the ratio to the width W [10], but the condition of the height T [10] may be set by the relationship with a length L instead of the width W [10]. That is, the multilayer ceramic capacitor 10 may be a tall height type in which the height T [10] is 1.3 times or more the length W [10]. The height T [10] may be 1.5 times or more the length L [10].

However, the size of the multilayer ceramic capacitor 10 is not necessarily required to have such a dimensional relationship. For example, the designed values may be selected from any one of the sizes of 0. 25 mm length, 0. 125 mm width, and 0. 125 mm height (0201 size), or 0. 4 mm length, 0. 2 mm width, and 0. 2 mm height (0402 size), or 0.6 mm length, 0.3 mm width, and 0.3 mm height (0603 size), or 1.0 mm length, 0.5 mm width, and 0.5 mm height (1005 size), or 3.2 mm length, 1.6 mm width, and 1.6 mm height (3216 size), or 4.5 mm length, 3.2 mm width, and 2.5 mm height (4532 size), or 5.7 mm length, 5.0 mm width, and 2.3 mm height (5750 size). The above sizes may include a dimensional tolerance of ±5 to 30%.

The ceramic body 11 includes the multilayer portion 20 and a pair of side margin portions 18. The multilayer portion 20 includes a capacitance forming portion 16 and a pair of cover portions 17. The capacitance forming portion 16 includes a plurality of first internal electrodes 12 and second internal electrodes 13 that are alternately stacked with a plurality of dielectric layers 19 along the Z-axis direction. In the present embodiment, the first internal electrode 12, the second internal electrode 13, and the dielectric layer 19 are each configured in a sheet shape extending along the X-Y plane. The stacked number of the first internal electrodes 12 and the stacked number of second internal electrodes 13 in each drawing do not represent the actual number of the stacked layers.

The first internal electrode 12 and the second internal electrode 13 are alternately arranged along the Z-axis direction so as to face each other in the Z-axis direction. The first internal electrode 12 and the second internal electrode 13 face each other in the Z-axis direction in a facing region at the center in the X-axis direction and the Y-axis direction. The first internal electrodes 12 correspond to a first group, are led out from the facing region to one end surface E11, and are connected to the first external electrode 14. The second internal electrode 13 correspond to a second group, are led out from the facing region to the other end surface E12, and are connected to the second external electrode 15.

The first internal electrode 12 and the second internal electrode 13 include a metal material as a main component. Typical examples of the metal material include nickel (Ni), and other examples include copper (Cu), palladium (Pd), platinum (Pt), silver (Ag), gold (Au), and alloys thereof.

With this configuration, in the multilayer ceramic capacitor 10, when a voltage is applied between the first external electrode 14 and the second external electrode 15, the voltage is applied to the plurality of dielectric layers 19 between the first internal electrode 12 and the second internal electrode 13 in the facing region. Thus, in the multilayer ceramic capacitor 10, electric charge corresponding to the voltage between the first external electrode 14 and the second external electrode 15 is stored.

In the multilayer portion 20, dielectric ceramics having a high dielectric constant is used in order to increase the capacitance of each dielectric layer 19 between the first internal electrode 12 and the second internal electrode 13. Examples of the dielectric ceramics having the high dielectric constant include materials having a perovskite structure containing barium (Ba) and titanium (Ti), typified by barium titanate (BaTiO₃).

The dielectric ceramics may be a composition system such as strontium titanate (SrTiO₃), calcium titanate (CaTiO₃), magnesium titanate (MgTiO₃), calcium zirconate (CaZrO₃), calcium zirconate titanate (Ca(Zr, Ti)O₃), barium calcium zirconate titanate ((Ba, Ca)(Zr, Ti)O₃), barium zirconate (BaZrO₃), and titanium oxide (TiO₂).

The pair of cover portions 17 cover the capacitance forming portion 16 from both sides in the Z-axis direction, which is the stacking direction. That is, as illustrated in FIG. 2A, the cover portions 17 are stacked on the main surfaces M16 of the capacitance forming portion 16 (hereinafter referred to as “capacitance forming portion main surfaces”). The cover portions 17 are parts of a protective layer in the height direction. The cover portion 17 is formed of, for example, a multilayer body of ceramic sheets extending along the X-Y plane. The dielectric ceramics constituting the cover portion 17 preferably have the same composition as the main component of the dielectric layer 19 from the viewpoint of suppressing the internal stress.

Referring to FIG. 2C, a capacitance forming portion main surface M16 facing in the Z-axis direction forms an interface between the capacitance forming portion 16 and the cover portion 17. The first particles 34 are present on the capacitance forming portion main surface M16 across the capacitance forming portion 16 and the cover portion 17. The first particles 34 may be the same as the first particles 32 described later.

The pair of side margin portions 18 are formed along the Z-axis direction and cover the multilayer portion 20 from the Y-axis direction. As illustrated in FIG. 2A, the side margin portions 18 are provided so as to cover the side surfaces S20 of the multilayer portion 20 (hereinafter referred to as “multilayer portion side surfaces”). The side margin portions 18 are parts of the protective layer. The multilayer portion side surfaces S20 also serve as side surfaces (hereinafter referred to as “capacitance forming portion side surfaces”) S16 of the capacitance forming portion 16 (see FIG. 5A and the like) in a region where the capacitance forming portion 16 is formed. Therefore, the side margin portion 18 covers the multilayer portion side surface S20, thereby covering the capacitance forming portion side surface S16 as well. The side margin portion 18 is formed on the multilayer portion side surface S20 perpendicular to the Y-axis. The dielectric ceramics constituting the side margin portion 18 preferably have the same composition as the main component of the dielectric layer 19 from the viewpoint of suppressing the internal stress.

Referring to FIG. 2B, the multilayer portion side surface S20 facing the Y-axis direction forms an interface between the multilayer portion 20 and the side margin portion 18. The first particles 32 are present on the multilayer portion side surface S20 across the multilayer portion 20 and the side margin portion 18. The first particles 32 will be described in detail later.

As illustrated in FIG. 3, the first external electrode 14 covers the first end surface E11 of the ceramic body 11 and extends to four surfaces located around the first end surface E11. That is, the first external electrode 14 extends to the pair of main surfaces M11 and M12. Although not illustrated, the first external electrode 14 extends to the pair of side surfaces S11 and S12 (see FIG. 2A).

As illustrated in FIG. 3, the second external electrode 15 covers the second end surface E12 of the ceramic body 11 and extends to four surfaces located around the second end surface E12. That is, the second external electrode 15 extends to the pair of main surfaces M11 and M12. Although not illustrated, the second external electrode 15 extends to the pair of side surfaces S11 and S12 (see FIG. 2A).

In the first external electrode 14 and the second external electrode 15, each of the cross section parallel to the X-Z plane and the cross section parallel to the X-Y plane has a U-shape. The shapes of the first external electrode 14 and the second external electrode 15 are not limited to the example illustrated in the drawings.

The first external electrode 14 and the second external electrode 15 contain a metal material as a main component. Examples of the metal material constituting the first external electrode 14 and the second external electrode 15 include copper (Cu), nickel (Ni), tin (Sn), palladium (Pd), platinum (Pt), silver (Ag), gold (Au), and alloys thereof. In the present embodiment, the main component refers to a component having the highest content ratio.

### <First Particle 32 and 34>

Here, the first particles 32 and 34 will be described in detail. As illustrated in FIG. 2B, the first particles 32 are disposed at the interfaces between the multilayer portion 20 and the side margin portions 18, that is, at the side surface S20 of the multilayer portion 20. The first particles 32 can strengthen the bonding force between the multilayer portion 20 and the side margin portions 18. The multilayer ceramic capacitor 10 of the present embodiment is a so-called tall height type, and a bonding area of the side margin portion 18 is large. By disposing the first particles 32, peeling of the side margin portion 18 can be suppressed even in the tall height type of multilayer ceramic capacitor 10. As illustrated in FIG. 2C, the first particles 34 are disposed at the interfaces between the capacitance forming portion 16 and the cover portions 17, that is, at the main surface M16 of the capacitance forming portion 16. The first particles 34 can strengthen the bonding force between the capacitance forming portion 16 and the cover portions 17.

In the present embodiment, the first particles 34 are disposed at the interfaces between the capacitance forming portion 16 and the cover portions 17, but the first particles 32 may be disposed at least at the interfaces between the multilayer portion 20 and the side margin portions 18. Referring to FIG. 3, the first particles 32 disposed at the interfaces between the multilayer portion 20 and the side margin portions 18 are distributed over the entire region of the multilayer portion 20 including the cover portions 17 when the multilayer portion 20 is viewed along the Y-axis direction. Although not illustrated, the first particles 34 disposed at the interfaces between the capacitance forming portion 16 and the cover portions 17 are distributed over the entire region of the capacitance forming portion 16 when the capacitance forming portion 16 is viewed along the Z-axis direction.

### <<Ratio of Short Side to Long Side of First Particle>>

The first particles 32 and 34 will be described in detail below. The first particle 32 in a case where the first particle 32 and the first particle 34 have a common property will be described. Referring to FIG. 4A, the first particle 32 has a needle-like shape with both ends pointed. The ratio of the length “a” of the short side to the length “b” of the long side of the first particle 32 having such a shape, that is, the aspect ratio (a:b) is ⅓ or less. The aspect ratio may be, for example, 0.3 or 0.2. As described later, the first particles 32 are sprayed toward the main surface M16 and the side surface S20, which are interfaces, in the manufacturing process of the multilayer ceramic capacitor 10. Then, the first particles 32 are stuck into the main surface M16 and the side surface S20. The cover portions 17 and the side margin portions 18 are provided on the main surface M16 and the side surface S20 in the state in which the first particles 32 are stuck. At this time, the other end sides of the first particles 32 are stuck into the cover portions 17 and the side margin portions 18. The first particles 32 have a shape with a predetermined aspect ratio, and thus can be stuck into both of predetermined bonding objects. In the manufacturing process of the multilayer ceramic capacitor 10, the organic component contained in the binder are discharged. At this time, it is considered that the efficiency of the discharge of the organic component can be improved when the first particles 32 have a shape with a predetermined aspect ratio. This will also be described in detail later.

### <<Composition of First Particles>>

The first particles 32 can be formed of Si-Al based glass. The Si—Al based glass particles may contain any of Si (silicon), Al (aluminum), Mn (manganese), Mg (magnesium), Zn (zinc), and rare earth elements. The first particles 32 may be particles formed of these elements in a single state or may be particles formed of compounds of these elements. The particles of the compound may contain the above elements as appropriate. The first particles 32 are formed of Si—Al based glass, and thus the moisture resistance of the multilayer ceramic capacitor 10 can be improved. These materials are selected as materials that can improve moisture resistance and can exhibit functions such as a sintering aid. Note that addition of Al makes it easy to obtain a crystal shape with a high aspect ratio.

The first particles 32 may include particles formed of either C (carbon) or Ag (silver). That is, each particle may be formed of C which is a single element, or may be formed of Ag which is a single element. However, for example, particles formed of C and particles formed of Ag may be used in a mixed state. Further, particles formed of C or particles formed of Ag may be mixed with particles formed of Si—Al based glass. The first particles 32 include particles formed of either C or Ag, and thus the strength of the multilayer ceramic capacitor 10 can be improved.

### <<Inclination Angle of First Particle>>

Next, the inclination angle of the first particle 32 will be described. Hereinafter, the inclination angle may be simply referred to as an angle. Referring to FIGS. 4B to 4D, an angle of the first particle 32 with respect to the perpendicular line NL1 to the side surface S20 of the multilayer portion 20, which is the interface between the multilayer portion 20 and the side margin portion 18, is indicated by α. The angle α is an angle formed by the perpendicular NL1 and the long side of the first particle 32. In the present embodiment, the angle α is set to 45 degrees or less. The angle α may be set counterclockwise with respect to the perpendicular line NL1 as illustrated in FIG. 4B, or may be set clockwise with respect to the perpendicular line NL1 as illustrated in FIG. 4C. Alternatively, the first particle 32 may have an angle α of 0° as illustrated in FIG. 4D. It is considered that the efficiency of discharging the organic component from the ceramic body 11 can be improved by setting the inclination angle of the first particles 32 in this manner. If the angle α is greater than 45 degrees, such as 50 degrees, the efficiency of the discharge of the organic component is considered to decrease. In addition, when the angle α is larger than 45 degrees, it is considered that the effect of improving the bonding force between the bonding objects is low.

Although FIGS. 4B to 4D illustrate a bonding portion between the multilayer portion 20 and the side margin portion 18, the angle α is similarly defined in the bonding portion between the capacitance forming portion 16 and the cover portion 17 illustrated in FIG. 2C. In this case, the angle α is the angle of the first particle 34 with respect to the perpendicular line NL2 to the main surface M16 of the capacitance forming portion 16.

The first particles 32 are not necessarily required to be provided in parallel. It is sufficient that the first particles 32 are set such that the angle α with respect to the perpendicular line NL1 or the perpendicular line NL2 is 45 degrees or less. For example, the first particles 32 in the states illustrated in FIGS. 4B to 4D may be mixed.

### <<Existence Rate of First Particles Having Predetermined Inclination Angle>>

Next, the existence rate of the first particles 32 having the inclination angle α of 45 degrees or less will be described. Here, the existence rate is, for example, a ratio of the first particles 32 having the inclination angle α of 45 degrees or less in the plurality of first particles 32 existing on the side surface S20 of the multilayer portion 20. The existence rate may be evaluated separately for the side surface S20 of the multilayer portion 20 and the main surface M16 of the capacitance forming portion 16. Alternatively, any region may be set, and the evaluation may be performed as the existence rate in the any region. In the present embodiment, the existence rate of the first particles 32 having the inclination angle α of 45 degrees or less is 80% or more.

It is considered that the efficiency of discharging the organic component is improved by setting the existence rate of the first particles 32 having the inclination angle α of 45 degrees or less to 80% or more. In addition, it is considered that the bonding force between the bonding objects can be improved.

### <<Ratio of Dimension of First Particle to Dimension of Second Particle Forming Protective Layer>>

Next, the ratio of the dimension of the first particle 32 to the dimension of a second particle 31 (33) forming the protective layer will be described.

As the protective layer, the side margin portion 18 is formed of a material having a perovskite structure containing barium (Ba) and titanium (Ti) as described above. In FIG. 2B, the second particles 31 forming the side margin portions 18 are depicted as having a substantially circular shape. However, FIG. 2B schematically illustrates the state of the S1 portion in FIG. 1A, and the shape of the second particles 31 and the ratio of the dimension of the first particle 32 to the dimension of the second particle 31 do not accurately represent the actual state.

The ratio of the dimension of the first particle 32 to the dimension of the second particle 31 in the present embodiment is 0.8 times or more and 2.0 times or less. Here, the dimension of the second particles 31 can be specified by, for example, measuring a plurality of maximum diameters of the particles from an end portion to an end portion of the particles and evaluating them by a D50 diameter. Specifically, a scanning electron microscope (SEM) cross-sectional photograph is taken, and the maximum grain diameters of a predetermined number (for example, 200 pieces) of second particles 31 are measured, and the evaluation can be performed by the D50 diameter. The second particles 31 in the present embodiment can be set to a range of 0.10 μm or more and 0.30 μm or less. Similarly, the dimension of the first particles 32 can be specified by, for example, measuring a plurality of maximum grain diameters from an end portion to an end portion of the particles and evaluating them by the D50 diameter. In detail, a SEM cross-sectional photograph is taken, and the maximum grain diameters of a predetermined number (for example, 200 pieces) of the first particles 32 are measured, and the evaluation can be performed by the D50 diameter. The first particles 32 in the present embodiment can be set to a range of 0.08 μm or more and 0.60 μm or less. The second particles 31 and the first particles 32 can be distinguished from each other based on the aspect ratio.

With such a ratio, the electrical characteristics of the multilayer ceramic capacitor 10 can be maintained. The first particles 32 are disposed in the capacitance forming portion 16. Therefore, the first particles 32 may become foreign matter in the capacitance forming portion 16. When the amount of impurities present in the capacitance forming portion 16 is increased, the short circuit rate in the multilayer ceramic capacitor 10 may increase. Here, the short circuit rate is a ratio of the multilayer ceramic capacitors 10 having conduction failures to a predetermined number (for example, 100 pieces) of multilayer ceramic capacitors 10.

Therefore, in the present embodiment, the ratio of the dimension of the first particle 32 to the dimension of the second particle 31 is set to 2.0 times or less, thereby avoiding the first particles 32 from acting as impurities in the capacitance forming portion 16. On the other hand, when the dimension of the first particle 32 is small, the bonding force between the bonding objects is reduced, and the possibility of occurrence of a sticking failure of the side margin portion 18 may be increased. Therefore, in the present embodiment, the ratio of the dimension of the first particle 32 to the dimension of the second particle 31 is set to 0.8 times or more to secure the bonding force between the bonding objects.

The relationship between the second particle 33 forming the cover portions 17 illustrated in FIG. 2C and the first particle 34 is the same as the relationship between the second particle 31 and the first particle 32.

### <<Existence Frequency of First Particles>>

Next, the existence frequency of the first particles 32 will be described. The existence frequency of the first particles 32 can be evaluated by a distance SP between the adjacent first particles 32 as illustrated in FIGS. 4B and 4D. FIGS. 4B and 4D schematically illustrate the arrangement of the first particles 32 in the cross section of the multilayer ceramic capacitor 10. Therefore, all the first particles 32 are not necessarily arranged at equal intervals while maintaining the distance SP. Therefore, the intervals between the first particles 32 are measured at a plurality of positions, and the average value thereof can be used for evaluation. The existence frequency of the first particles 32 in the present embodiment can be set in a range of 1 μm/piece or more and 2 μm/piece or less. That is, the distance SP can be set to 1 μm or more and 2 μm or less. When the existence frequency of the first particles 32 is converted into the number of first particles 32 per unit area, the range is 0.25 piece/μm² or more and 1 piece/μm² or less.

When the existence frequency is set to a value larger than 2 μm/piece, the bonding force between the bonding objects is reduced, and the side margin portion 18 may be peeled off. On the other hand, when the existence frequency is set to be smaller than 1 μm/piece, the first particles 32 are closer to each other, and the short circuit rate may increase. For example, when the first particles 32 are formed of conductive particles such as C or Ag, the first particles 32 disposed between the first internal electrode 12 and the second internal electrode 13 may cause the short circuit. In addition, in a case where the first particles 32 are formed of non-conductive particles such as Si or Al, when the first particles 32 are disposed between the first internal electrode 12 and the second internal electrode 13, the electric field concentration occurs at the positions thereof, and dielectric breakdown is likely to occur.

Here, a difference in action due to a difference in the existence frequency of the first particles 32 will be described with reference to FIGS. 5A to 5C. Such a difference in the existence frequency is caused by a difference in the addition amount of the first particles 32. As illustrated by arrows la in FIG. 5A, the first particles 32 form degassing flow paths through which the organic component is discharged. The formation of such degassing flow paths promotes the discharge of the organic component, and the time for debinding in the manufacturing process can be shortened.

Next, referring to FIG. 5B, the additive amount of the first particles 32 is increased, and the first particles 32 are closer to each other compared with a state illustrated in FIG. 5A. In a state illustrated in FIG. 5B, the bonding force between the bonding objects can be improved while securing the degassing flow paths.

Next, referring to FIG. 5C, a state is illustrated in which the additive amount of the first particles 32 is further increased compared with the state illustrated in FIG. 5B. FIG. 5C illustrates a state in which the first particles 32 adjacent to each other in the manufacturing process of the multilayer ceramic capacitor 10 are agglomerated as a result of the first particles 32 being too close to each other. The first particles 32 are changed to first particles 32′ having a large aspect ratio by being agglomerated. When the first particles 32′ are formed, the degassing flow path is blocked, and the organic component is less likely to be discharged. As a result, the debinding time is prolonged. In addition, the wedge effect of the first particles 32′ is reduced, and the side margin portions 18 and the cover portions 17 are likely to peel off. Furthermore, the area of the first particles 32′ entering the capacitance forming portion 16 increases, and as a result, the short circuit rate may increase.

The existence frequency of the first particles 32 in the present embodiment can be evaluated by the number of first particles 32 per unit area in consideration of these actions of the first particles 32. The existence frequency of the first particles 32 can be appropriately set in a range of 0.25 piece/μm² or more and 1 piece/μm² or less.

The existence frequency of the first particles 32 may be evaluated by the number of first particles 32 per unit distance. In this case, the existence frequency of the first particles 32 can be appropriately set in a range of 1 μm/piece or more and 2 μm/piece or less. Here, the expression “1 μm/piece” means that the first particles 32 are arranged at intervals of 1 μm along the X-axis direction or the Y-axis direction. The expression “2 μm/piece” means that the first particles 32 are arranged at intervals of 2 μm along the X-axis direction or the Y-axis direction.

The number of first particles 32 per unit distance and the number of first particles 32 per unit area can be converted in the following manner. For example, when the number of first particles 32 per unit distance is 1 μm/piece, one first particle 32 is present in a range of 1 μm×1 μm. That is, it is 1 μm²/piece. Therefore, this state is expressed by the number of first particles 32 per unit area, which is 1 piece/μm². Similarly, when the number of first particles 32 per unit distance is 2 μm/piece, one first particle 32 is present within a range of 2 μm×2 μm. That is, it is 4 μm²/piece. Therefore, when this state is expressed by the number of first particles 32 per unit area, it is 0.25 piece/μm².

### <<Ratio of Dimension of Portion Located in Capacitance Forming Portion and Dimension of Portion Located in Side Margin>>

Next, the ratio of a dimension b1 of a portion of the first particle 32 located in the capacitance forming portion 16 and a dimension b2 of a portion of the first particle 32 located in the side margin portion 18 will be described with reference to FIG. 4B. The first particles 32 are disposed across the capacitance forming portion 16 and the side margin portions 18. At this time, the first particles 32 are arranged at the boundary between the capacitance forming portion 16 and the side margin portion 18 so that the ratio b1:b2 of the dimensions b of the long sides of the first particles 32 is in the range of 1:3 or more and 3:1 or less. When the bl is small, the influence on the electrical characteristics is small, but the adhesion effect is low. Conversely, when the bl is large, the influence on the electrical characteristics is large, but on the other hand, the adhesion effect is large. By setting the ratio b1:b2 in consideration of the balance between these, it is possible to reduce the short circuit rate in the multilayer ceramic capacitor 10 and improve the bonding force between the capacitance forming portion 16 and the side margin portion 18.

This ratio is also applied to the first particles 32 disposed in the bonding portion between the cover portion 17 and the side margin portion 18. That is, this ratio is applied to the entire region of the bonding portion between the multilayer portion 20 and the side margin portion 18.

The ratio between the dimension of the portion located in the capacitance forming portion 16 and the dimension of the portion located in the cover portion can also be set to the same ratio.

### Manufacturing Method

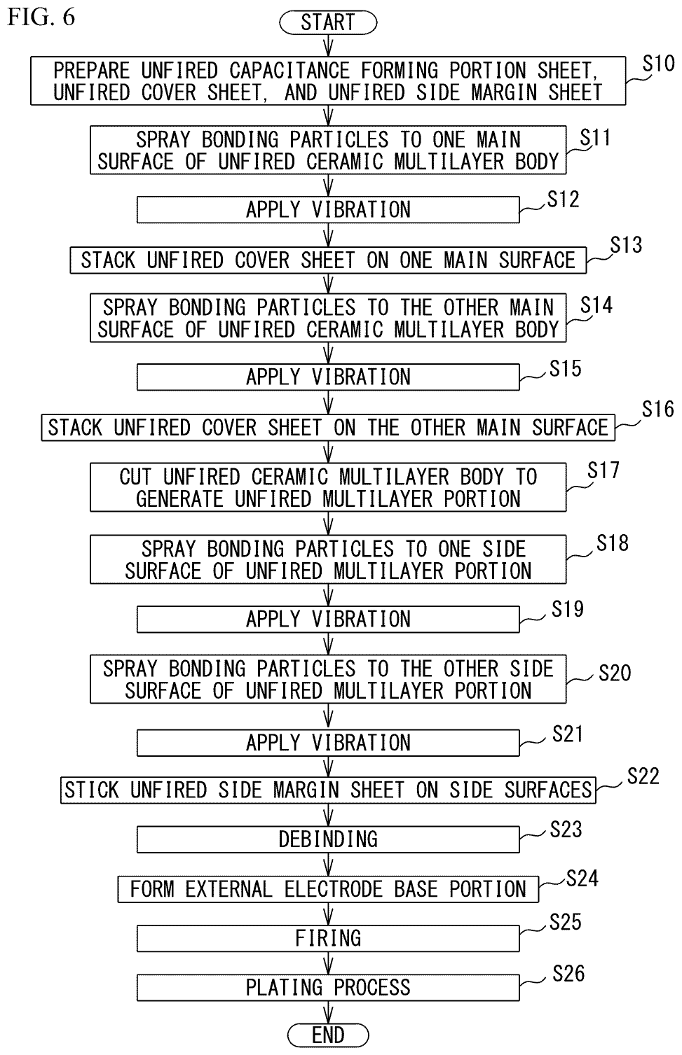

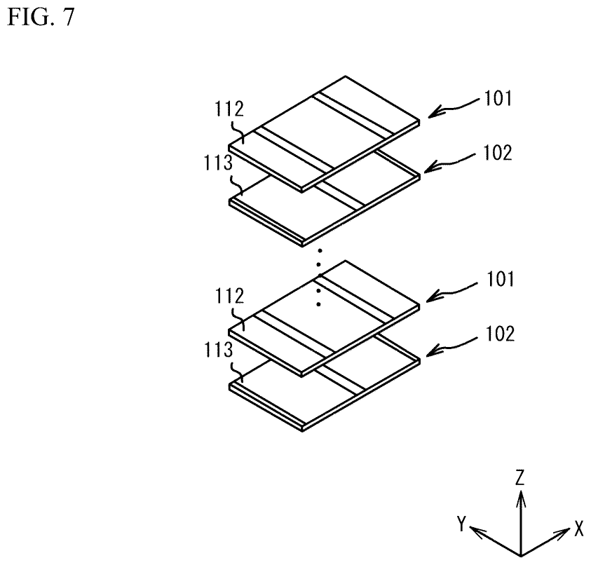

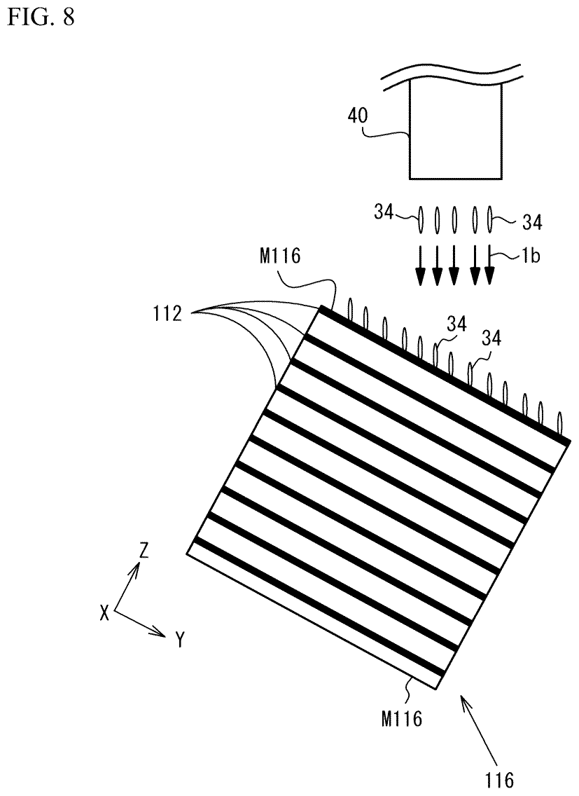

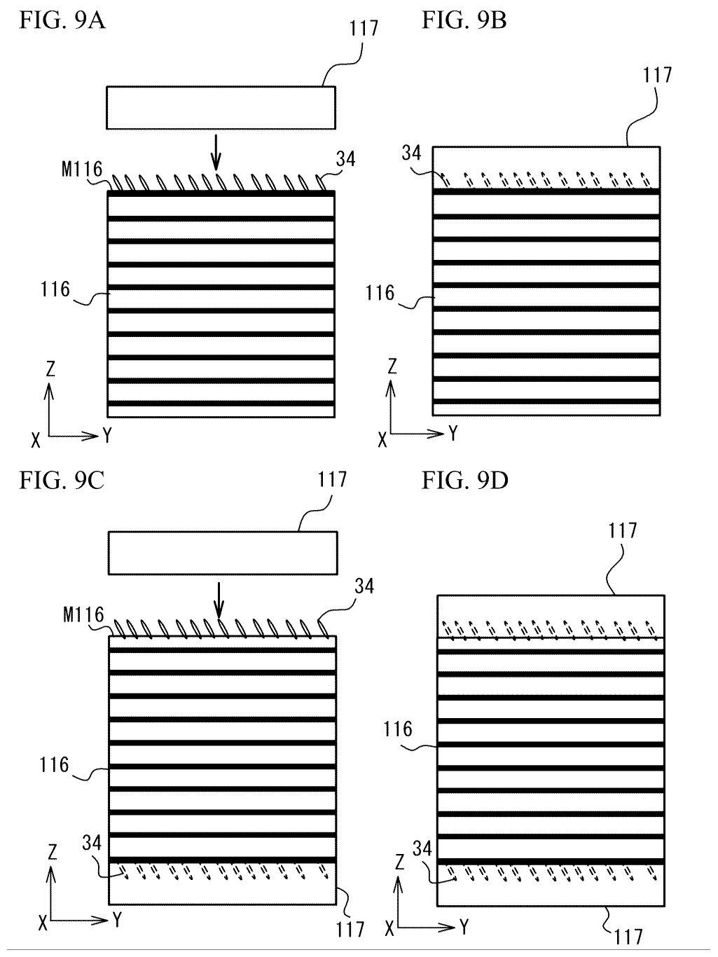

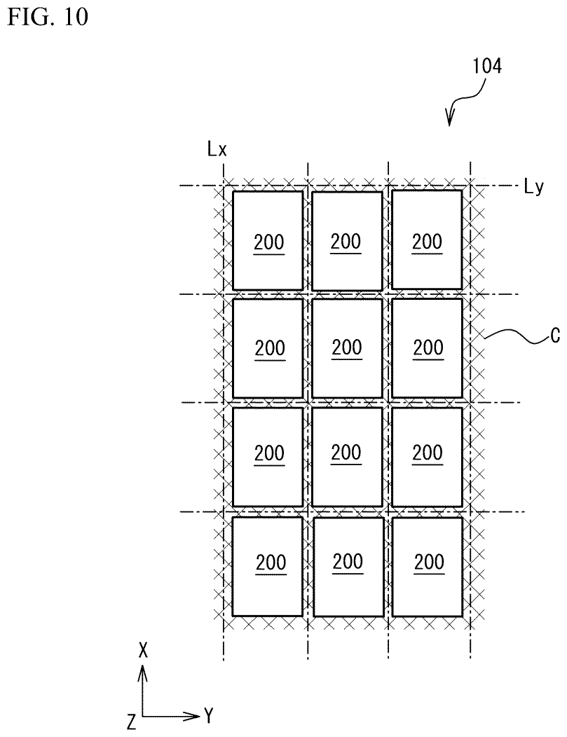

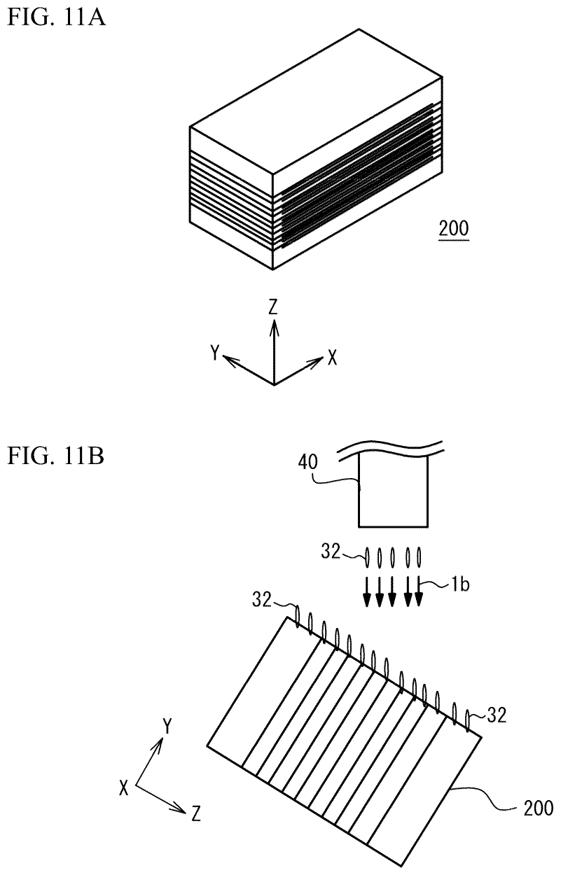

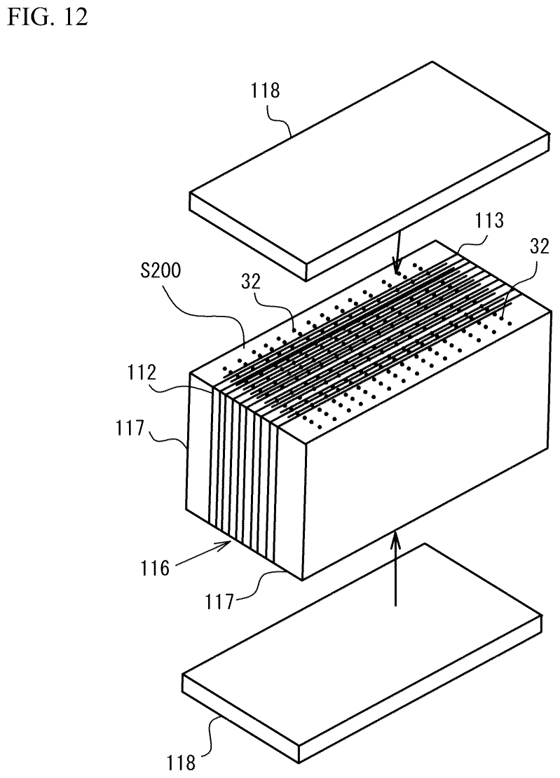

Next, an example of a method of manufacturing the multilayer ceramic capacitor 10 will be described with reference to FIGS. 6 to 12B. FIG. 6 is a flowchart illustrating an example of a method of manufacturing the multilayer ceramic capacitor 10 according to the embodiment. FIG. 7 is a perspective view illustrating a part of steps included in the method of manufacturing the multilayer ceramic capacitor 10 of the embodiment. FIG. 8 is an explanatory view schematically illustrating a state in which the first particles 34 are sprayed onto the main surface M16 of the capacitance forming portion 16. FIGS. 9A to 9D are explanatory views illustrating some steps included in the method of manufacturing the multilayer ceramic capacitor 10 according to the embodiment. FIG. 10 is a plan view illustrating a cutting step included in the method of manufacturing the multilayer ceramic capacitor 10 according to the embodiment. FIG. 11A is a perspective view of an unfired multilayer portion 200 formed by cutting a multilayer sheet 104 on which the cover portions 17 are stacked, and FIG. 11B is an explanatory view schematically illustrating a state in which the first particles 32 are sprayed onto a side surface S200 of the unfired multilayer portion 200. FIG. 12 is an explanatory diagram schematically illustrating a state in which unfired side margin sheets 118 for forming the side margin portions 18 are stuck on the side surfaces of the unfired capacitance forming portion to which the first particles 32 have been sprayed.

In step S10, unfired capacitance forming portion sheets 101 and 102 (see FIG. 7), unfired cover sheets 117 (see FIGS. 9A to 9D), and the unfired side margin sheets 118 (see FIG. 12) are prepared.

First, materials for forming each sheet are blended. Specifically, an organic binder and an organic solvent as a dispersing agent and a molding aid are added to a dielectric material powder, and the mixture is pulverized and mixed to produce a slurry in a muddy state. The dielectric material powder includes, for example, ceramic powder. The dielectric material powder may contain an additive. The additive is, for example, an oxide of Mg, Mn, V, Cr, Y, Sm, Eu, Gd, Tb, Dy, Ho, Er, Tm, Yb, Co, Ni, Li, B, Na, K, or Si, or glass. The organic binder is, for example, a polyvinyl butyral resin or a polyvinyl acetal resin. The organic solvent is, for example ethanol or toluene.

In the present embodiment, as described later, the first particles 32 are used for bonding an unfired ceramic multilayer body 116 and the unfired cover sheets 117 to each other and bonding the unfired multilayer portion 200 and the unfired side margin sheets 118 to each other. The first particles 32 improve the bonding force between the bonding objects. Therefore, in the present embodiment, the amount of the organic binder can be reduced as compared with the conventional art.

Next, the unfired capacitance forming portion sheets 101 and 102 are produced by applying slurry containing ceramic powder in which the materials are blended as described above onto a carrier film in a sheet shape and drying the slurry. The carrier film is, for example, a PET (polyethylene terephthalate) film. The slurry may be applied by a doctor blade method, a die coater method, a gravure coater method, or the like.

Then, the conductive paste for internal electrodes is applied to the green sheets of the layers in which the first internal electrode 12 and the second internal electrode 13 are formed among the plurality of green sheets so as to form predetermined patterns. Thus, the unfired capacitance forming portion sheet 101 on which an internal electrode pattern 112 is formed and the unfired capacitance forming portion sheet 102 on which an internal electrode pattern 113 is formed are obtained. The conductive paste for internal electrodes contains a powder of a metal used as a material of the first internal electrode 12 and the second internal electrode 13. For example, when the metal used as the material of the first internal electrode 12 and the second internal electrode 13 is Ni, the conductive paste for internal electrodes contains Ni powder. The conductive paste for internal electrodes includes a binder, a solvent, and an auxiliary agent as necessary. The conductive paste for internal electrodes may include, as a co-material, a ceramic material that is a main component of the dielectric layer 19. The conductive paste for internal electrodes may be applied by a screen printing method, an inkjet printing method, a gravure printing method, or the like.

As illustrated in FIG. 7, the unfired capacitance forming portion sheets 101 and 102 are stacked along the Z-axis direction to form the unfired ceramic multilayer body 116 that is the capacitance forming portion 16.

The unfired cover sheet 117 and the unfired side margin sheet 118 are prepared by forming the green sheets to a predetermined thickness.

Next, in step S11, the first particles 34 are sprayed onto the stacked unfired capacitance forming portion sheets 101 and 102, that is, onto one main surface M116 of the unfired ceramic multilayer body 116. The first particles 34 are sprayed by, for example, a blasting method. The first particles 34 are sprayed in the vertical direction as indicated by arrows 1b by a nozzle 40. In contrast, the unfired ceramic multilayer body 116 is disposed such that the main surface M116 has a predetermined angle with respect to a direction indicated by the arrows 1b. Here, the predetermined angle is an angle that can realize the angle α illustrated in FIG. 4B or FIG. 4C. The unfired ceramic multilayer body 116 is placed on a stage on which an adhesive sheet is laid, for example, in order to be installed at such an angle.

Note that, by spraying the first particles 34 while heating the unfired ceramic multilayer body 116, the first particles 34 can be easily stuck into the main surface M116.

The amount of the first particles 34 to be sprayed is appropriately set based on the specifications of the final product.

The direction in which the first particles 34 are sprayed and the main surface M116 may be arranged so that a predetermined angle therebetween can be realized. For example, the main surface M116 may be set to be horizontal, and the nozzle 40 may be set in a direction rotated from the vertical direction.

Next, vibration is applied to the unfired ceramic multilayer body 116 in step S12. As a result, the first particles 34 that cannot be stuck into the main surface M116 are removed. The unfired cover sheet 117 is stacked on the main surface M116 in a later step. By vibrating the unfired ceramic multilayer body 116, the excess first particles 34 that do not contribute to bonding between the main surface M116 and the unfired cover sheet 117 are removed. Instead of the vibration, for example, the excessive first particles 34 may be removed by blowing air.

Next, in step S13, the unfired cover sheet 117 is stacked on one main surface M116. Referring to FIGS. 9A and 9B, the unfired cover sheet 117 is stacked on the one main surface M116 of the unfired ceramic multilayer body 116 to which the first particles 34 are sprayed. At this time, the first particles 34 can be easily stuck into the unfired cover sheet 117 by pressing the unfired cover sheet 117 relatively against the main surface M116 while heating the unfired cover sheet 117.

Next, the first particles 34 are sprayed onto the unfired capacitance forming portion sheets 101 and 102 stacked in step S14, that is, onto the other main surface M116 of the unfired ceramic multilayer body 116. In addition, the unfired ceramic multilayer body 116 is vibrated in step S15. These steps are common to steps S11 and S12. Therefore, the detailed description thereof is omitted here.

Next, in step S16, the unfired cover sheet 117 is stacked on the other main surface M116. Referring to FIGS. 9C and 9D, the unfired cover sheet 117 is stacked on the other main surface M116 of the unfired ceramic multilayer body 116 to which the first particles 34 are sprayed. At this time, the first particles 34 can be easily stuck into the unfired cover sheet 117 by pressing the unfired cover sheet 117 relatively against the main surface M116 while heating the unfired cover sheet 117.

After the unfired cover sheet 117 is stacked on both the main surfaces M116, the unfired ceramic multilayer body 116 is pressed to pressure-bond the stacked green sheets. As a method of pressure-bonding the unfired ceramic multilayer body 116, for example, a method of sandwiching the multilayer block between resin films and performing isostatic pressing can be used.

Next, the unfired ceramic multilayer body 116 is cut into individual pieces in step S17, and the unfired multilayer portion 200 (see FIG. 11A) having a rectangular parallelepiped shape is formed. The unfired multilayer portion 200 corresponds to the multilayer portion 20 after firing. Referring to FIG. 10, the unfired multilayer portion 200 is formed by cutting the unfired ceramic multilayer body 116 along cutting lines Lx and Ly. For cutting the unfired ceramic multilayer body 116, for example, a push cutting blade, a rotary blade, or the like can be used.

Next, in step S18, as illustrated in FIG. 11B, the first particles 32 are sprayed onto one side surface S200 of the unfired multilayer portion 200. Then, the unfired multilayer portion 200 is vibrated in step S19. In step S20, the first particles 32 are sprayed to the other side surface S200 of the unfired multilayer portion 200. Then, the unfired multilayer portion 200 is vibrated in step S21. These steps can be performed in the same manner as steps S11 and S12. Therefore, when the first particles 32 are sprayed in steps S18 and S20, the side surface S200 is relatively inclined so that the direction of spraying the first particles 32 indicated by the arrows 1b and the side surface S200 form a predetermined angle as illustrated in FIG. 11B. Thereby, the inclination angle α (see FIGS. 4B to 4D) is formed. In addition, by spraying the first particles 32 while heating the unfired multilayer portion 200, the first particles 32 can be easily stuck into the side surface S200.

Next, in the step S22, as illustrated in FIG. 12, the unfired side margin sheets 118 are stuck on both the side surfaces S200. The unfired side margin sheet 118 is pressed against and stuck on the side surface S200 while being heated. This makes it possible to make the first particles 32 easily stick into the unfired side margin sheet 118. As a method of sticking the unfired side margin sheet 118 on the side surface S200, a conventionally known method can be adopted. When the unfired side margin sheet 118 is laid, the unfired multilayer portion 200 is disposed thereon, and the unfired side margin sheet 118 and the unfired multilayer portion 200 are bonded to each other, the unfired side margin sheet 118 is attached to the side surface S200 by the weight of an unfired multilayer portion 110. Here, by pressing the unfired side margin sheet 118 against the side surface S200, the unfired side margin sheet 118 can be more reliably stuck on the unfired multilayer portion 200.

Next, a debinding process is performed in step S23. The debinding process removes the organic binder contained in the unfired multilayer portion 200 on which the unfired side margin sheet 118 is stuck. In the removal of the organic binder, the unfired multilayer portion 200 is heated in an N2 atmosphere at about 350° C., for example. In the present embodiment, the amount of the organic binder itself can be reduced, and further, the degassing flow paths are secured as illustrated in FIG. 5A and FIG. 5B. Therefore, the time required for the debinding process can be shortened.

Next, an external electrode base portion is formed in the step S24, and then the firing is performed in step S25. Then, a plating process is performed to form the first external electrode 14 and the second external electrode 15 in step S26. For these steps, a conventionally known method can be adopted. Therefore, the detailed description thereof is omitted here.

Through the above steps, the multilayer ceramic capacitor 10 of the present embodiment can be obtained.

### Effects

In the multilayer ceramic capacitor 10 of the present embodiment, the first particles 32 (34) are disposed at the interfaces between the capacitance forming portion 16, and the cover portions 17 and the side margin portions 18, and thus peeling of these bonding portions can be suppressed. In addition, by disposing the first particles 32 (34), the amount of the organic binder can be reduced. When the amount of the organic binder increases, the debinding property deteriorates, and the liquid component increases, so that the denseness of the multilayer ceramic capacitor 10 deteriorates. When the denseness deteriorates, the moisture resistance of the multilayer ceramic capacitor 10 deteriorates, and the reliability of the product decreases. Therefore, it is considered to increase the firing temperature in order to improve the denseness. However, when the firing temperature is increased, there is a concern that the electrical characteristics of the multilayer ceramic electronic component may be deteriorated, such as the internal electrodes becoming spherical or the continuity modulus of the internal electrodes being deteriorated. In the present embodiment, the first particles 32 (34) are included, and thus it is possible to suppress the peeling of the side margin portions 18 and the cover portions 17 without increasing the amount of the organic binder. In addition, since the amount of the organic binder is small, it is possible to secure a good debinding property.

### EXAMPLES

Next, examples of the multilayer ceramic capacitor 10 described in the embodiment will be described with reference to Tables 1 and 2 while being compared with comparative examples.

As examples, first to seventh examples were prepared. As comparative examples, first to eighth comparative examples were prepared. However, among the first to seventh examples, in the fourth example, the first particles were added only to the interfaces of the cover portions 17, and in the other examples, the first particles were added only to the interfaces of the side margin portions 18.

Table 1 illustrates specifications of the first to the fourth examples and the first to the third comparative examples. Table 1 illustrates the shortened time of the debinding and the sticking failure rate in these examples and these comparative examples. Table 2 illustrates specifications of the first example, the fifth to the seventh examples, and the fourth to the eighth comparative examples. Table 2 illustrates the short circuit rate and the sticking failure rate in these examples and these comparative examples.

The shortened time of the debinding is expressed by a percentage of the time taken to complete the debinding compared to the time required for the debinding in the first comparative example. Whether the debinding is completed is determined based on whether the weight of the unfired multilayer portion 200 before the start of the debinding process has reached the weight of the unfired multilayer portion 200 expected to be obtained by the debinding. The sticking failure rate is calculated from the result of visual inspection of whether the side margin portion 18 and the cover portion 17 are peeled off. The short circuit rate was calculated as a ratio of the number of capacitors having conduction failure to 100 multilayer ceramic capacitors.

In the first example, the particle diameter ratio was 0.8, the aspect ratio of the first particles 32 was 0.3, the frequency of the first particles 32 was 0.25 piece/μm² (2 μm/piece), the set value of the angle α of the first particles 32 was 30 degrees, and the existence rate of the first particles 32 having the angle α of 30 degrees was 80%. The frequency of the first particles 32 was measured by a method of counting the number of first particles 32 present in a range of 10 μm×10 μm=100 μm² in the SEM image and converting the number into the number per 1 μm². This method is the same in other examples and the comparative examples.

In the second example, the particle diameter ratio was 0.8, the aspect ratio of the first particles 32 was 0.3, the frequency of the first particles 32 was 0.25 piece/μm² (2 μm/piece), the set value of the angle α of the first particles 32 was 45 degrees, and the existence rate of the first particles 32 having the angle α of 45 degrees was 80%.

In the third example, the particle diameter ratio was 0.8, the aspect ratio of the first particles 32 was 0.3, the frequency of the first particles 32 was 0.25 piece/μm² (2 μm/piece), the set value of the angle α of the first particles 32 was 30 degrees, and the existence rate of the first particles 32 having an angle α of 30 degrees was 100%.

In the fourth example, the particle diameter ratio was 0.8, the aspect ratio of the first particles 34 was 0.3, the frequency of the first particles 34 was 0.25 piece/um² (2 μm/piece), the set value of the angle α of the first particles 34 was 30 degrees, and the existence rate of the first particles 32 having the angle α of 30 degrees was 80%. However, the first particles 34 in the fourth example were added only to the interfaces of the cover portions 17 as described above.

In the fifth example, the particle diameter ratio was 2.0, the aspect ratio of the first particles 32 was 0.3, the frequency of the first particles 32 was 0.25 piece/um² (2 μm/piece), the set value of the angle α of the first particles 32 was 30 degrees, and the existence rate of the first particles 32 having the angle α of 30 degrees was 80%.

In the sixth example, the particle diameter ratio was 0.8, the aspect ratio of the first particles 32 was 0.2, the frequency of the first particles 32 was 0.25 piece/μm² (2 μm/piece), the set value of the angle α of the first particles 32 was 30 degrees, and the existence rate of the first particles 32 having the angle α of 30 degrees was 80%.

In the seventh example, the particle diameter ratio was 0.8, the aspect ratio of the first particles 32 was 0.3, the frequency of the first particles 32 was 1 piece/μm² (1 μm/piece), the set value of the angle α of the first particles 32 was 30 degrees, and the existence rate of the first particles 32 having the angle α of 30 degrees was 80%.

On the other hand, the first comparative example is a mode in which the first particles 32 are not used.

In the second comparative example, the particle diameter ratio was 0.8, the aspect ratio of the first particles 32 was 0.3, the frequency of the first particles 32 was 0.25 piece/μm² (2 μm/piece), the set value of the angle α of the first particles 32 was 50 degrees, and the existence rate of the first particles 32 having the angle α of 50 degrees was 80%.

In the third comparative example, the particle diameter ratio was 0.8, the aspect ratio of the first particles 32 was 0.3, the frequency of the first particles 32 was 0.25 piece/μm² (2 μm/piece), the set value of the angle α of the first particles 32 was 30 degrees, and the existence rate of the first particles 32 having the angle α of 30 degrees was 75%.

In the fourth comparative example, the particle diameter ratio was 0.7, the aspect ratio of the first particles 32 was 0.3, the frequency of the first particles 32 was 0.25 piece/μm² (2 μm/piece), the set value of the angle α of the first particles 32 was 30 degrees, and the existence rate of the first particles 32 having the angle α of 30 degrees was 80%.

In the fifth comparative example, the particle diameter ratio was 2.1, the aspect ratio of the first particles 32 was 0.3, the frequency of the first particles 32 was 0.25 piece/μm² (2 μm/piece), the set value of the angle α of the first particles 32 was 30 degrees, and the existence rate of the first particles 32 having the angle α of 30 degrees was 80%.

In the sixth comparative example, the particle diameter ratio was 0.8, the aspect ratio of the first particles 32 was 0.5, the frequency of the first particles 32 was 0.25 piece/μm² (2 μm/piece), the set value of the angle α of the first particles 32 was 30 degrees, and the existence rate of the first particles 32 having the angle α of 30 degrees was 80%.

In the seventh comparative example, the particle diameter ratio was 0.8, the aspect ratio of the first particles 32 was 0.3, the frequency of the first particles 32 was 0.16 piece/μm² (2.5 μm/piece), the set value of the angle α of the first particles 32 was 30 degrees, and the existence rate of the first particles 32 having the angle α of 30 degrees was 80%. In a state where the frequency is 2.5 μm/piece, one first particle 32 is present in a range of 2.5 μm×2.5 μm. That is, it is 6.25 μm²/piece. Therefore, when this state is expressed by the number of first particles 32 per unit area, the frequency of the first particles is 0.16 piece/μm².

In the eighth comparative example, the particle diameter ratio was 0.8, the aspect ratio of the first particles 32 was 0.3, the frequency of the first particles 32 was 4 piece/μm² (0.5 μm/piece), the set value of the angle α of the first particles 32 was 30 degrees, and the existence rate of the first particles 32 having the angle α of 30 degrees was 80%. In a state where the frequency is 0.5 μm/piece, one first particle 32 is present in a range of 0.5 μm×0.5 μm. That is, it is 0.25 μm²/piece. Therefore, this state is expressed by the number of first particles 32 per unit area, the frequency of the first particles 32 is 4 piece/μm².

First, the first example and the first comparative example are compared. The sticking failure rate of the first example and the sticking failure rate of the first comparative example were both 0%. However, the shortened time of the debinding in the first example was 50%. That is, in the first example, the debinding was completed in half the time of the first comparative example. This is considered to be because the amount of the organic binder can be reduced in the first example, and the first particles 32 form the degassing flow paths, and thus have a good debinding property.

Next, the second example and the second comparative example are compared. The shortened time of the debinding in the second example was 55%. The shortened time of the debinding in the second comparative example was 60%. When the second example and the second comparative example are compared, the angle α of the first particle 32 of the second example is 45 degrees, whereas the angle α of the first particle 32 of the second comparative example is 50 degrees. From these results, it can be evaluated that the debinding property is reduced when the angle α is too large, that is, when the first particles 32 are too parallel to the interface. The sticking failure rate of the second example was 1%. The sticking failure rate of the second comparative example was 10%. From this result, it can be evaluated that peeling is likely to occur when the angle α is too large. From these results, the upper limit of the angle α can be set to 45 degrees.

Next, the third example and the third comparative example are compared. The shortened time of the debinding in the third example was 50%. The shortened time of the debinding in the third comparative example was 55%. The sticking failure rate of the third example was 0%. The sticking failure rate of the third comparative example was 7%. When the third example and the third comparative example are compared, the existence rate of the first particles 32 having the angle α of 30 degrees in the third example is 100%, whereas the existence rate of the first particles 32 having the angle α of 30 degrees in the third comparative example is 75%. From this result, it can be evaluated that when the existence rate of the first particles 32 having the angle α of 30 degrees is decreased, the debinding time is extended, and the sticking failure is likely to occur. From this result, it is desirable that the existence rate of the first particles 32 having the angle α of 30 degrees is 80% or more adopted in the first example.

Next, the fourth embodiment will be described. The first particles 34 in the fourth example were added only to the interfaces of the cover portions 17, but the shortened time of the debinding could be 50% as in the first example. In addition, the sticking failure rate was able to be reduced to 0%. The evaluation of the sticking failure rate in the fourth example is an evaluation of the cover portion 17.

Next, the fifth example and the fourth and the fifth comparative examples are compared. The sticking failure rate of the fifth example is 0%. The short circuit rate of the fifth example is 0%. In contrast, the sticking failure rate of the fourth comparative example is 10%, and the short circuit rate is 0%. In the fifth comparative example, the sticking failure rate is 7%, and the short circuit rate is 10%. When comparing the fifth example with the fourth and the fifth comparative examples, the particle diameter ratio in the fifth example is 2.0, and the particle diameter ratio in the fourth comparative example is 0.7. The particle diameter ratio in the fifth comparative example is 2.1. The particle diameter ratio of the fourth comparative example is smaller than the particle diameter ratio of 0.8 in the first example. Therefore, it can be evaluated that the sticking failure rate increases when the particle diameter of the first particle 32 is too small. From this result, a lower limit of the particle diameter ratio can be set to 0.8 times as employed in the first example. On the other hand, from the results of the fifth comparative example, it is considered that the short circuit rate increases when the particle diameter ratio is too large. From this result, an upper limit of the particle diameter ratio can be set to 2.0 times as employed in the fifth example.

Next, the sixth example and the sixth comparative example are compared. The sticking failure rate of the sixth example is 0%. The short circuit rate of the sixth example is 0%. In contrast, the sticking failure rate of the sixth comparative example is 50%, and the short circuit rate is 30%. When the sixth example and the sixth comparative example are compared, the aspect ratio in the sixth example is 0.2, and the aspect ratio in the sixth comparative example is 0.5. Therefore, it can be evaluated that when the aspect ratio becomes equal to or larger than a predetermined value, the sticking failure rate increases and the short circuit rate also increases. This is probably because the first particles 32 are less likely to be stuck and the area of the first particles 32 embedded in the capacitance forming portion 16 increases as the aspect ratio increases. From these results, the upper limit of the aspect ratio can be set to 0.3 adopted in the first example.

Next, the seventh example and the seven and the eighth comparative examples are compared. The sticking failure rate of the seventh example is 0%. The short circuit rate of the seventh example is 0%. In contrast, the sticking failure rate of the seventh comparative example is 6%, and the short circuit rate is 0%. The sticking failure rate of the eighth comparative example is 0%, and the short circuit rate is 5%. When the seventh example is compared with the seventh and the eighth comparative examples, the frequency of the first particles 32 in the seventh example is 1 piece/μm² (1 μm/piece), and the frequency of the first particles 32 in the seventh comparative example is 0.16 piece/μm² (2.5 μm/piece). The frequency of the first particles 32 in the eighth comparative example is 4 piece/μm² (0.5 μm/piece). Therefore, it can be evaluated that the sticking failure rate increases when the frequency of the first particles 32 is too low, and the short circuit rate increases when the frequency of the first particles 32 is too high. As a result, the frequency of the first particles 32 can be set to 0.25 piece/μm² or more (2 μm/piece or less) adopted in the first example and 1 piece/μm² or less (1 μm/piece or more) adopted in the seventh example.

TABLE 1

| | | | | | EXISTENCE |
|---|---|---|---|---|---|
| | PARTICLE | | | | RATE OF |
| | DIAMETER | | | | FIRST |
| | RATIO | FIRST | | | PARTICLE |
| | [FIRST | PARTICLE | FIRST | FIRST | SATISFYING |
| | PARTICLE/ | ASPECT | PARTICLE | PARTICLE | ANGLE |
| | BT | RATIO | FRE- | ANGLE α | CONDITION |
| | PARTICLE] | LONG SIDE] | QUENCY | (DEGREE) | [%] |
| FIRST | 0.8 | 0.3 | 0.25 | 30 | 80 [%] |
| EXAMPLE | | | PIECE/μm² | | |
| SECOND | 0.8 | 0.3 | 0.25 | 45 | 80 [%] |
| EXAMPLE | | | PIECE/μm² | | |
| THIRD | 0.8 | 0.3 | 0.25 | 30 | 100 [%] |
| EXAMPLE | | | PIECE/μm² | | |
| FOURTH | 0.8 | 0.3 | 0.25 | 30 | 80 [%] |
| EXAMPLE | | | PIECE/μm² | | |
| FIRST | — | — | — | — | — |
| COM- | | | | | |
| PARATIVE | | | | | |
| EXAMPLE | | | | | |
| SECOND | 0.8 | 0.3 | 0.25 | 50 | 80 [%] |
| COM- | | | PIECE/μm² | | |
| PARATIVE | | | | | |
| EXAMPLE | | | | | |
| THIRD | 0.8 | 0.3 | 0.25 | 30 | 75 [%] |
| COM- | | | PIECE/μm² | | |
| PARATIVE | | | | | |
| EXAMPLE | | | | | |
| | | FIRST | SHORTENED | STICKING | |
| | | PARTICLE | TIME OF | FAILURE | |
| | | ADDITIVE | DEBINDING | RATE | EVAL- |
| | | POSITION | [%] | [%] | UATION |
| | FIRST | INTERFACE | 50 [%] | 0 [%] | ◯ |
| | EXAMPLE | OF SIDE | | | |
| | | MARGIN | | | |
| | SECOND | INTERFACE | 55 [%] | 1 [%] | ◯ |
| | EXAMPLE | OF SIDE | | | |
| | | MARGIN | | | |
| | THIRD | INTERFACE | 50 [%] | 0 [%] | ◯ |
| | EXAMPLE | OF SIDE | | | |
| | | MARGIN | | | |
| | FOURTH | INTERFACE | 50 [%] | 0 [%] | ◯ |
| | EXAMPLE | OF COVER | | | |
| | FIRST | — | 100 [%] | 0 [%] | — |
| | COM- | | | | |
| | PARATIVE | | | | |
| | EXAMPLE | | | | |
| | SECOND | INTERFACE | 60 [%] | 10 [%] | X |
| | COM- | OF SIDE | | | |
| | PARATIVE | MARGIN | | | |
| | EXAMPLE | | | | |
| | THIRD | INTERFACE | 55 [%] | 7 [%] | Δ |
| | COM- | OF SIDE | | | |
| | PARATIVE | MARGIN | | | |
| | EXAMPLE | | | | |

TABLE 2

| | | | | | EXISTENCE |
|---|---|---|---|---|---|
| | | | | | RATE OF |
| | PARTICLE | FIRST | | | BONDING |
| | DIAMETER | PARTICLE | FIRST | FIRST | PARTICLE |
| | RATIO FIRST | ASPECT RATIO | PARTICLE | PARTICLE | SATISFYING |
| | [PARTICLE/BT | [SHORT SIDE/ | FRE- | ANGLE α | ANGLE |
| | PARTICLE] | LONG SIDE] | QUENCY | (DEGREE) | CONDITION |
| FIRST | 0.8 | 0.3 | 0.25 | 30 | 80 [%] |
| EXAMPLE | | | PIECE/μm² | | |
| FIFTH | 2.0 | 0.3 | 0. 25 | 30 | 80 [%] |
| EXAMPLE | | | PIECE/μm² | | |
| SIXTH | 0.8 | 0.2 | 0.25 | 30 | 80 [%] |
| EXAMPLE | | | PIECE/μm² | | |
| SEVENTH | 0.8 | 0.3 | 1 | 30 | 80 [%] |
| EXAMPLE | | | PIECE/μm² | | |
| FOURTH | 0.7 | 0.3 | 0.25 | 30 | 80 [%] |
| COM- | | | PIECE/μm² | | |
| PARATIVE | | | | | |
| EXAMPLE | | | | | |
| FIFTH | 2.1 | 0.3 | 0.25 | 30 | 80 [%] |
| COM- | | | PIECE/μm² | | |
| PARATIVE | | | | | |
| EXAMPLE | | | | | |
| SIXTH | 0.8 | 0.5 | 0. 25 | 30 | 80 [%] |
| COM- | | | PIECE/μm² | | |
| PARATIVE | | | | | |
| EXAMPLE | | | | | |
| SEVENTH | 0.8 | 0.3 | 0.16 | 30 | 80 [%] |
| COM- | | | PIECE/μm² | | |
| PARATIVE | | | | | |
| EXAMPLE | | | | | |
| EIGHTH | 0.8 | 0.3 | 4 | 30 | 80 [%] |
| COM- | | | PIECE/μm² | | |
| PARATIVE | | | | | |
| EXAMPLE | | | | | |
| | | FIRST | SHORT | STICKING | |
| | | PARTICLE | CIRCUIT | FAILURE | |
| | | ADDITIVE | RATE | RATE | EVAL- |
| | | POSITION | [%] | [%] | UATION |
| | FIRST | INTERFACE OF | 0 [%] | 0 [%] | ◯ |
| | EXAMPLE | SIDE MARGIN | | | |
| | FIFTH | INTERFACE OF | 0 [%] | 0 [%] | ◯ |
| | EXAMPLE | SIDE MARGIN | | | |
| | SIXTH | INTERFACE OF | 0 [%] | 0 [%] | ◯ |
| | EXAMPLE | SIDE MARGIN | | | |
| | SEVENTH | INTERFACE OF | 0 [%] | 0 [ %] | ◯ |
| | EXAMPLE | SIDE MARGIN | | | |
| | FOURTH | INTERFACE OF | 0 [%] | 10 [%] | X |
| | COM- | SIDE MARGIN | | | |
| | PARATIVE | | | | |
| | EXAMPLE | | | | |
| | FIFTH | INTERFACE OF | 10 [%] | 7 [%] | X |
| | COM- | SIDE MARGIN | | | |
| | PARATIVE | | | | |
| | EXAMPLE | | | | |
| | SIXTH | INTERFACE OF | 30 [%] | 50 [%] | X |
| | COM- | SIDE MARGIN | | | |
| | PARATIVE | | | | |
| | EXAMPLE | | | | |
| | SEVENTH | INTERFACE OF | 0 [%] | 6 [%] | X |
| | COM- | SIDE MARGIN | | | |
| | PARATIVE | | | | |
| | EXAMPLE | | | | |
| | EIGHTH | INTERFACE OF | 5 [%] | 0 [%] | Δ |
| | COM- | SIDE MARGIN | | | |
| | PARATIVE | | | | |
| | EXAMPLE | | | | |

In each of the above-described embodiments, the multilayer ceramic capacitor is described as an example of a multilayer ceramic electronic component, but the present disclosure is not limited thereto. For example, the configurations of the above-described embodiments are applicable to other multilayer ceramic electronic components such as varistors and thermistors.

Although the embodiments of the present disclosure are described in detail above, the present disclosure is not limited to the specific embodiments. It is to be understood that the various change, substitutions, and alterations could be made hereto without departing from the spirit and scope of the invention.

What is claimed is:

1. A multilayer ceramic electronic component comprising:
a capacitance forming portion in which dielectric layers and internal electrodes are alternately stacked along a first axis direction, the capacitance forming portion including a pair of main surfaces facing each other along the first axis direction, a pair of side surfaces facing each other in a second axis direction orthogonal to the first axis direction and on which the internal electrodes are exposed, and a pair of end surfaces facing each other in a third axis direction orthogonal to the first axis direction and the second axis direction;
a protective layer that covers the capacitance forming portion with the main surfaces and the side surfaces as interfaces;
particles that are present across the capacitance forming portion and the protective layer, and in which, when a longest portion in a cross section including a direction along the first axis direction is defined as a long side and a longest portion in portions orthogonal to the long side is defined as a short side, a ratio of the short side to the long side is equal to or less than ⅓; and
a pair of external electrodes that cover at least the end surfaces, respectively.

2. The multilayer ceramic electronic component according to claim 1,
wherein the protective layer includes side margin portions covering the side surfaces from directions along the second axis direction, and
wherein the particles are present across the capacitance forming portion and the side margin portions with the side surfaces, which are the interfaces between the capacitance forming portion and the side margin portions, interposed therebetween.

3. The multilayer ceramic electronic component according to claim 1,
wherein the capacitance forming portion forms a multilayer portion together with cover portions which are included in the protective layer and stacked along the first axis direction, and
wherein the particles are present across the capacitance forming portion and the cover portions with the main surfaces, which are the interfaces between the capacitance forming portion and the cover portions, interposed therebetween.

4. The multilayer ceramic electronic component according to claim 1,
wherein the particles contain any one of Si, Al, Mn, Mg, Zn, and a rare earth element.

5. The multilayer ceramic electronic component according to claim 1,
wherein the particles contain any one of C and Ag.

6. The multilayer ceramic electronic component according to claim 1,
wherein when the first axial direction is defined as a height direction, the second axial direction orthogonal to the first axial direction is defined as a width direction, and the third axial direction orthogonal to the first axial direction and the second axial direction is defined as a length direction, a height dimension of the multilayer ceramic electronic component is about 1.3 times or more a width dimension or a length dimension of the multilayer ceramic electronic component.

7. The multilayer ceramic electronic component according to claim 1,
wherein each of the particles has an inclination angle of 45 degrees or less with respect to a perpendicular line of the interfaces.

8. The multilayer ceramic electronic component according to claim 7,
wherein an existence rate of the particles having an inclination angle of 45 degrees or less is 80% or more.

9. The multilayer ceramic electronic component according to claim 1,
wherein a ratio of dimensions of the particles to dimensions of particles forming the protective layer is 0.8 times or more and 2.0 times or less.

10. The multilayer ceramic electronic component according to claim 1,
wherein an existence frequency of the particles is 0.25 piece/μm² or more and 1 piece/μm² or less.

11. The multilayer ceramic electronic component according to claim 2,
wherein a ratio of a dimension of a portion of each of the particles located in the capacitance forming portion to a dimension of a portion of each of the particles located in the side margin portions is in a range of 1:3 to 3:1.

12. The multilayer ceramic electronic component according to claim 3,
wherein a ratio of a dimension of a portion of each of the particles located in the capacitance forming portion to a dimension of a portion of each of the particles located in the cover portions is in a range of 1:3 to 3:1.

13. A method of manufacturing a multilayer ceramic electronic component comprising:
forming an unfired multilayer portion in which dielectric layers and internal electrodes are alternately stacked along a first axis direction, the unfired multilayer portion including a pair of main surfaces facing each other along the first axis direction, a pair of side surfaces facing each other in a second axis direction orthogonal to the first axis direction and on which the internal electrodes are exposed, and a pair of end surfaces facing each other in a third axis direction orthogonal to the first axis direction and the second axis direction, the internal electrodes being led out to the pair of end surfaces, respectively;
spraying particles each having a ratio of a short side to a long side of ⅓ or less to the side surfaces; and
sticking ceramic sheets on the side surfaces to which the particles are sprayed, the ceramic sheets forming the side margin portions.

14. The method of manufacturing the multilayer ceramic electronic component according to claim 13, comprising:
vibrating the unfired multilayer portion to remove excess particles on the side surfaces, the vibrating being performed after the spraying the particles.

15. The method of manufacturing the multilayer ceramic electronic component according to claim 13,
wherein in the spraying the particles, the side surfaces are inclined with respect to a spraying direction of the particles.

16. The method of manufacturing the multilayer ceramic electronic component according to claim 13,
wherein in the spraying the particles, the particles are sprayed to the side surfaces while heating the unfired multilayer portion.

17. The method of manufacturing the multilayer ceramic electronic component according to claim 13,
wherein in the sticking the ceramic sheets on the side surfaces, the ceramic sheets are pressed against the side surfaces while being heated.

18. The method of manufacturing the multilayer ceramic electronic component according to claim 13,
wherein in the sticking the ceramic sheets on the side surfaces, the ceramic sheets forming the side margin portions are pressed and stuck.

19. The method of manufacturing the multilayer ceramic electronic component according to claim 13,
wherein the forming the unfired multilayer portion includes:
spraying particles each having a ratio of a short side to a long side of about ⅓ or less to surfaces of a ceramic multilayer body facing in the first axis direction, the ceramic multilayer body including ceramic sheets each including an unfired internal electrode, the ceramic sheets being stacked along the first axis direction; and
stacking ceramic sheets forming cover portions on the surfaces to which the particles are sprayed.
